(19) United States
(12) Patent Application Publication
(10) Pub. No.: US 2009/0288035 A1
(43) Pub. Date: Nov. 19, 2009

(54) SCROLLABLE VIEWS IN A CLIENT/SERVER APPLICATION

(75) Inventors: Brian Tunning, Shanghai (CN); Shen Wei, Shanghai (CN); Jun Cai, Shanghai (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/120,649

(22) Filed: May 15, 2008

(51) Int. Cl. G06F 3/048

(52) U.S. Cl. 715/784

(57) ABSTRACT

Described herein is technology for, among other things, a method of displaying a number of views in response to user scrolling. A basic, generic view is initially rendered for display on a client. Subsequent views are rendered for display that tracks the scrolling. During the scrolling process, data is not requested from the server. Only data that is stored on the client device is used while scrolling. When the scrolling has deemed to have stopped, the client requests additional data from the server. This additional data is rendered for display and is also stored in the locally on the client. Subsequent views containing this data can be generated quickly because the data exists locally. Thereby, views can be quickly and smoothly scrolled through and will appear richer in content over time.

### BACKGROUND

The Internet is fast becoming integral to the way corporations, consumers, and individuals conduct business, communicate, and access information on a daily basis. The Internet evolved by using network devices to connect computers together to effectively form a worldwide, publicly accessible series of interconnected data networks. Typically, a user accesses the Internet through a web browser on his or her personal “client” computer. The web browser is a piece of software that is used to display a web page. The web page is actually hosted or stored on a remote “server” computer connected to the Internet. To access a particular web page, the web browser requests the server to obtain the corresponding text, graphics, and audio/video data. If authorized, the server transmits the data, which the client's browser then uses to generate the web page to the user. Typically, a web page contains hyperlinks to other web pages. This enables the user to quickly and easily access information provided on related web sites by traversing the hyperlinks. In this manner, users can browse various web sites of interest hosted by any number of servers over the Internet.

The Internet has proven to be so popular, versatile, and useful that a wide range of software applications have been adapted or developed to be run through the browser. These software applications retain standard, basic user interfaces. Typically, a mouse is used to move a cursor over the web browser. A button on the mouse is depressed to make a selection. Thereby, a user can point-and-click on icons to perform specific, pre-defined actions. A user can also point-and-click on up, down, left, and right arrows to traverse the web page. Furthermore, a user can point-and-click on an item from a list displayed on a pull-down menu.

Another user interface that is typically associated with browsers entails scrolling. Traditionally, scrolling is a mechanism whereby a user clicks and drags a scroll bar to move an object up and down for display. For example, a user can scroll the pages of a text document either up or down for display. Scrolling in one direction causes preceding pages to be displayed, whereas scrolling in the opposite direction causes the succeeding pages to be displayed. Likewise, scrolling in the context of a web page causes the text and graphics of that web page to move up and down. In many cases, the downloaded web page extends beyond what can be displayed on a web browser. The user can quickly and easily scroll up and down the web page to glean information of interest. Because scrolling was being used extensively, developers implemented a scroll wheel. A user physically rotates a wheel laterally to provide the scrolling function. The scroll wheel is typically mounted vertically on the mouse. Moving a downloaded web page by rotating the scroll wheel with one finger is much easier and quicker than clicking and dragging a scroll bar up and down the side of a browser.

Although users have become quite accustomed to using a scroll wheel, the scroll wheel has been generally limited to simply moving downloaded web pages upwards and downwards. Other functions are provided by the more traditional point-and-click mechanisms. These traditional point-and-click mechanisms can be quite cumbersome and error-prone. It can sometimes be counter-intuitive as to which buttons or icons are used to invoke certain specific functions. Hence, it is quite unfortunate that hitherto, web-based software applications fail to take full advantage of the scrolling feature conferred by traditional scroll wheels.

Furthermore, if the user scrolls to a section that has yet to be downloaded, it may take some time to request and retrieve the data from the server. The scrolling may stop to allow time for the browser to obtain the data from the server or scrolling may just cause a blank page to appear. In either case, the user experiences a less than satisfactory experience.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, a scrolling mechanism that enables a user to scroll through a wide spectrum of views. When the user scrolls through the views, the views are rendered for display from data that currently resides in a local memory. Initially, only basic, generic data is loaded into the local memory. When the user stops scrolling, the application requests a server for additional information corresponding to that view. This additional information is then rendered for display as part of that view. The additional information is also cached in the local memory so that it can appropriately be used in rendering subsequent views. In this manner, the user can quickly and smoothly scroll through the views without having to wait for data to be requested and retrieved from the server. And as additional data is fetched and cached in its local memory, the views become richer in content over time, without sacrificing scrollability.

In one embodiment, the scrolling mechanism is used to navigate a web-based calendar. A web browser is used to generate a generic view of a calendar. The user can scroll up and down through the days of the week, weeks of the month, or months of the year. A timer is used to determine when the user has stopped scrolling. Once the scrolling has deemed to have stopped, any non-generic data that had previously been entered (e.g., appointments) is requested and retrieved from the server and rendered for display on the browser. The user can also click on a field and enter data (e.g., click on a day to enter an appointment). This information is sent to the server for storage. Thereby, a user can access his or her calendar through any web browser and quickly and efficiently scroll through the contents of the calendar with minimal lag and delay.

### BRIEF DESCRIPTION OF THE DRAWINGS

The accompanying drawings, which are incorporated in and form a part of this specification, illustrate various embodiments and, together with the description, serve to explain the principles of the various embodiments.

FIG. 1 is a flowchart describing the process for generating scrollable views in a client/server application according to one embodiment.

FIG. 2 is a flowchart describing the process for detecting a scroll wheeling event according to one embodiment.

FIG. 3 is a flowchart showing the process for using a mouse wheel to scroll through views according to one embodiment.

FIG. 4 shows a client/server diagram for implementing one embodiment of the scrollable view software application.

FIG. 5 shows a monthly view of the web based calendar.

FIG. 6 shows the user entering two appointments.

FIG. 7 shows a view whereby the user rotates the scroll wheel to display a view corresponding the range of Jan. 6, 2008-Feb. 9, 2008.

FIG. 8 shows the monthly view corresponding to the range of Jan. 13, 2008-Feb. 16, 2008.

FIG. 9 shows the monthly view with a range of Jan. 6, 2008-Feb. 9, 2008.

FIG. 10 shows the monthly view corresponding to the range of Dec. 30, 2007-Feb. 2, 2008.

FIG. 11 shows the monthly view corresponding to the range of Dec. 23, 2007-Jan. 26, 2008.

### DETAILED DESCRIPTION

Reference will now be made in detail to the preferred embodiments, examples of which are illustrated in the accompanying drawings. While the disclosure will be described in conjunction with the preferred embodiments, it will be understood that they are not intended to limit the disclosure to these embodiments. On the contrary, the disclosure is intended to cover alternatives, modifications and equivalents, which may be included within the spirit and scope of the disclosure as defined by the claims. Furthermore, in the detailed description, numerous specific details are set forth in order to provide a thorough understanding of the disclosure. In other instances, well known methods, procedures, components, and circuits have not been described in detail as not to unnecessarily obscure aspects of the disclosure.

Scrollable views in a client/server application are now described. Generally, a software application running on the browser utilizes some form of generic text and graphics data. For example, the generic text and graphics data can define a pre-determined background or template suitable for that particular software application. The client computer requests this generic text and graphics data from the server computer and stores the data locally in its own memory. Because this generic text and graphics data is now cached internally by the client computer, the software application can generate the graphics and text for display on the browser virtually instantaneously. As a result, this generic display can be generated on-the-fly to track the movement of the scroll wheel. This provides a smooth, fast, and visually appealing views displayed by the browser as the user rotates the scroll wheel up and down.

A view is defined as an image that is displayed in a portion of a web browser, window, menu, or other user interface that enables a user to look at and/or interact with text, graphics, videos, pictures, music, multi-media, and other types of audio/visual content. Scrolling the view in context of the present embodiments is not limited to just moving images up and down for display. Scrolling encompasses many other functions. For example, scrolling can be time-based. Rotating the wheel can cause a calendar to display dates earlier or later in time. Alternatively, scrolling can be made to zoom in or zoom out (either as a function in time or space). Furthermore, scrolling can be used to move forwards or backwards when viewing a video or to listen to different points of a music file. In short, scrolling can be applied to any axis that represents linear data.

These views often have fields that display user-specific or user-input data; proprietary data; any type of processed data; or data that is subject to change that may be of interest to the user. When the user stops rotating the wheel, the client computer determines which fields (if any) are currently viewable on the browser. The data (e.g., numbers, text, or images) corresponding to these fields are then downloaded from the server, cached, and rendered for display by the browser. Thereby, the next time the user scrolls through a view that contains these fields, the data can be promptly rendered for display directly from its own internal cache memory. There is no need to request and wait for the data to be downloaded off the Internet. This provides the user with a framework from which he or she can operate, without having to wait for exchanges over the Internet between the client and server.

In one embodiment, the client only requests data from the server when the user stops rotating the scroll wheel. It is highly likely that the point at which he or she stops rotating the scroll wheel is of some interest to the user. Consequently, in one embodiment, all of the relevant data corresponding to that particular view is requested and downloaded from the server. This data is cached by the client computer. And, as soon as the user begins rotating the scroll wheel again, the browser generates views from previously cached data. As the user periodically scrolls through different views, more and more data is cached. Thereby, over time, scrollable views that are fast, smooth, uninterrupted, and content rich can be generated in real-time for display by the browser.

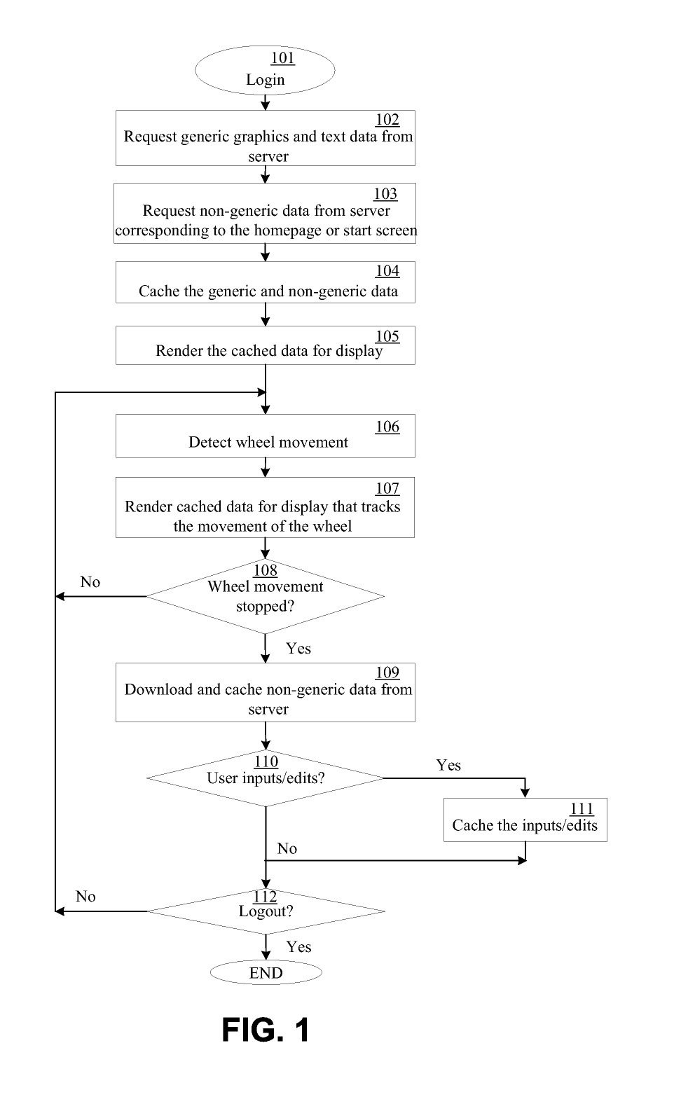

FIG. 1 is a flowchart describing the process for generating scrollable views in a client/server application according to one embodiment. The user logs in, step 101, from his or her client computer. The client computer can be a personal computer, laptop, or any electronic device capable of transmitting and receiving data. The client computer can also be a communications device (e.g., a personal digital assistant, cell phone, or some form of mobile/handheld device). Upon successful login, the software application launches and requests the generic graphics and text data from the server, step 102. The generic graphics and text data is the data that is common to all users for that particular application. For example, in a calendar application, the generic graphics data would be the grids corresponding to the days of the week; the weeks of the month; and months of the year. The generic text would be the numerical representation of each day of a month (e.g., 1-28, 29, 30, or 31), days of the week (e.g., Mon-Sun), months of the year (e.g., January-December), and the calendar years (e.g., 2008).

The client computer also requests non-generic data corresponding to the homepage or start screen from the server, step 103. This non-generic data is data that is not common across all the users. Non-generic data include user-specific or user-input data (e.g., appointments in calendar application). It can also include proprietary data, such as financial information pertaining to an individual's stock or bank account. Non-generic data can include any type of processed data or data that is subject to change that may be of interest to the user (e.g., news, charts, video, pictures, music, etc.).

Both the generic and non-generic data obtained from the server are cached in the memory of the client computer, step 104. In one embodiment, the data exits as HyperText Markup Language (HTML) for web pages. The cached data corresponding to the starting view is then rendered for display, step 105.

When the user rotates the scroll wheel, this movement is detected by the software application, step 106. Any cached data corresponding to the views that track the movement of the scroll wheel are rendered for display, step 107. Initially, the views will be the generic data and the non-generic data corresponding to the homepage or start screen. However, additional non-generic data will subsequently be cached and rendered for display according to steps 108-112.

In step 108, the software application determines whether the wheel has stopped moving. When the software application determines that the wheel has not moved for a pre-determined amount of time, it downloads and caches any non-generic data from the server, step 109. The non-generic data corresponds to the particular view at the point where the scroll wheel stopped at. The software application also detects whether the user has made any changes or edits to the view, step 110. Any user inputs and edits are locally cached, step 111. For example, in a calendar application, the user may scroll to a particular day and time to enter an appointment. This appointment is then cached in the internal memory of the client computer. In one embodiment, this data is also transmitted and stored on the server computer. This enables the user to access the data if he or she switches to a different client computer.

Step 112 determines if the user logs out. If the user logs out, the software application ends. Otherwise, the process returns to step 106. The user may rotate the scroll wheel. If the scroll wheel is rotated, the cached data is rendered for display. Because the data exists in the client computer's cache memory, it can be rendered quickly and smoothly. As the user scrolls, the views can be generated on-the-fly to track the movement of the scroll wheel. This is done without the lag, latency, or irregularities associated with traditional client/server processes. It is only when the scroll wheel has been deemed to have stopped, does the client computer request, download, cache, and render the non-generic data for display. Consequently, the more times the user starts and stops scrolling, more and more data is being cached. This means that the subsequent views grow richer in appearance and contain more data.

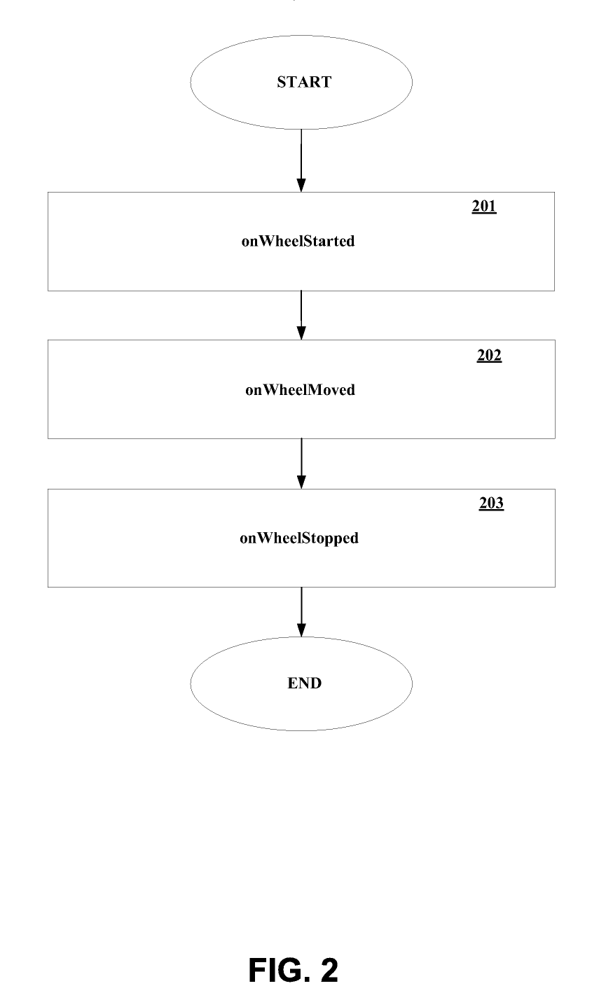

FIG. 2 is a flowchart describing the process for detecting a scroll wheeling event according to one embodiment. The software application implements a wheeling Control class that is browser independent. The wheeling Control class generates three kinds of messages: an on WheelStarted, an on WheelMoved, and an on WheelStopped message. The on WheelStarted message 201 is generated once users begin to rotate the scroll wheel over a certain area of the browser. The wheel control is aware of this occurrence automatically and sends this message in response thereto. If users keep rotating the scroll wheel, the wheel control maintains an internal reference count to indicate how many times the user rotates the scroll wheel. This gives an indication as to the degree that the scroll wheel has been rotated. The count does not depend on the browser or system. The wheel control then generates and sends this count as a parameter in a WheelMoved message, step 202. When it is deemed that the user has stopped rotating the scroll wheel, an on WheelStopped message is generated, step 203. It is not possible to absolutely know the moment when a user has decided to stop rotating the scroll wheel. Thus, a mechanism is used to predict if a user really wants to stop the scrolling. A timer is set up whereby if a user does not rotate the scroll wheel for a pre-determined amount of time, the timer elapses. This condition is considered to mean that the user desires to stop rotating the scroll wheel. The on WheelStopped message prompts the software application to request data from the remote server and render it out for display. It should be noted that in one embodiment, the data is requested from the server only upon the generation of an on WheelStopped message, step 203. This greatly improves the performance because, otherwise, obtaining data from the server for each incremental rotation of the scroll wheel would result in extremely slow and laggy scroll speed due to the time it would take to obtain the data from the server.

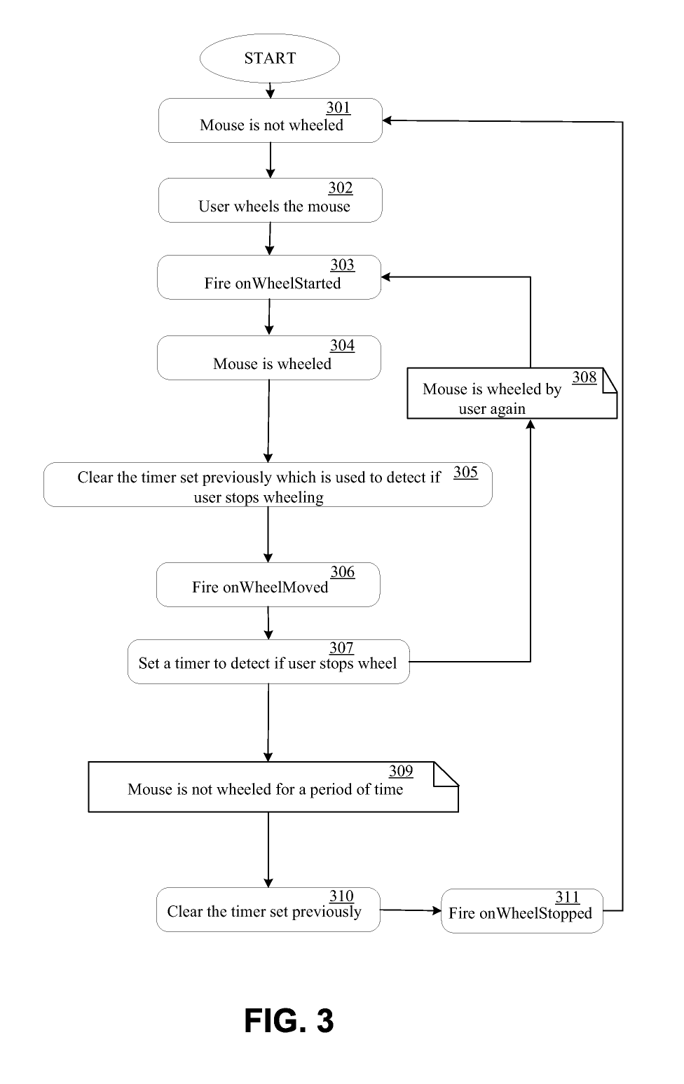

FIG. 3 is a flowchart showing the process for using a mouse wheel to scroll through views according to one embodiment. The process can be applied to a client/server software application as well as a stand-alone software application that is not coupled to the Internet or other network. Initially, in step 301, the mouse wheel is not being wheeled. In other words, it is stationary. The mouse wheel is a physical device that is in the shape of a rotatable wheel that is mounted on a mouse or some other type of cursor control device. The user decides to change the view and starts to wheel the mouse, step 302. Thereupon, the on WheelStarted message is fired, step 303. The user continues to wheel the mouse, step 304. Any previously set timer is cleared, step 305. This timer is used to detect if the user stops wheeling the mouse. Next, an on WheelMoved message is fired, step 306. A timer is now set to detect if the user stops moving the wheel, step 307. If the user continues to be wheeled by the user, as determined by step 308, another on WheelStarted message is fired and the process reverts back to step 303. However, if the mouse has not been wheeled for a pre-determined period of time, as determined in step 309, the previously set time is cleared, step 310. Furthermore, the on WheelStopped message is fired 311. The process begins anew at step 301.

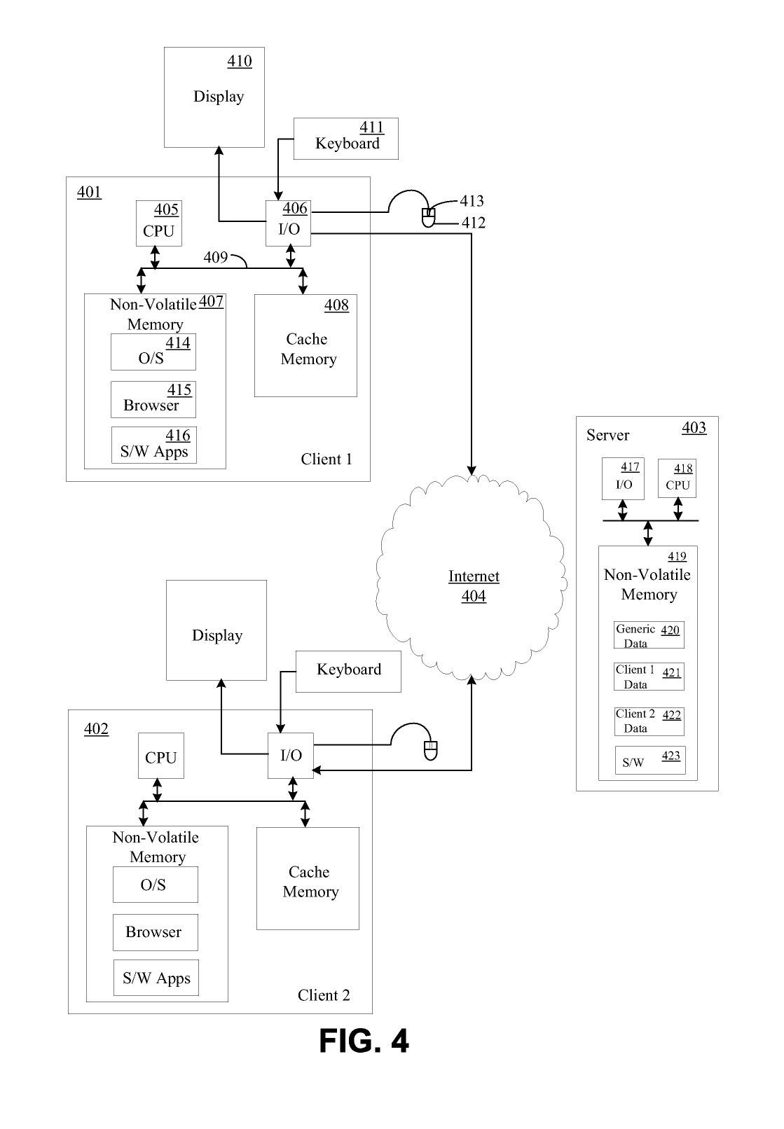

FIG. 4 shows a client/server diagram for implementing one embodiment of the scrollable view software application. Two client devices 401 and 402 are coupled to a server device 403 through the Internet 404 or through a network. Client device 401 includes a central processing unit (CPU) 405, an input/output (I/O) unit 406, non-volatile memory 407, and cache memory 408. They are coupled together by virtue of bus 409. The CPU 405 processes data according to the software stored in the non-volatile memory 407. I/O unit 406 includes a network interface to transmit and receive data to/from the Internet 404. The I/O unit also outputs graphics, text, and/or video for display on screen 410. It can also play audio (e.g., music or voice) on speakers and accept input from a microphone (not shown). The I/O also accepts inputs from keyboard 411 and mouse 412. Mouse 412 includes a scroll wheel 413. Non-volatile memory 407 is used to store software and data. The stored information is retained even when the client device is powered down. Some examples of non-volatile memory include read-only memory (ROM), flash memory, and hard disk drives. It is used to store an operating system 414, browser 415, and various software applications 416. The client device 401 also includes cache memory 408. Cache memory 408 is random access memory and is used to store data.

Likewise, client device 402 also includes a CPU, an I/O unit, non-volatile memory, and cache memory, all of which are coupled together by a bus. The client device 402 is coupled to a display, keyboard, and a mouse with a scroll wheel. The client device can access server device 403 through the Internet 404.

Server device 403 includes an I/O unit 417, CPU 418, and non-volatile memory 419. Non-volatile memory 419 can be an internal or external device that contains generic data 420 as well as user-specific data. For example, user specific data corresponding to the user on the client device 401 is stored in one section 421 of the non-volatile memory 419. Meanwhile, user specific data corresponding to a different user on client device 402 is stored in a separate section 422 of non-volatile memory 419. Non-volatile memory 419 also contains one or more software applications 423.

The depicted client/server configuration functions as follows. First, the user on client device 401 launches a browser and specifies an address of the web site being hosted on server device 403. The server authenticates the user and runs the software application to generate the html data to be transmitted to the browser of client device 401. The html data includes the generic data 420 and a portion of the client data 421 corresponding to the homepage or start menu. This html data is transmitted over the Internet 404 to be rendered for display on the browser of client device 401. This html data is also stored in cache memory 408 of the client device 401. When the user scrolls the view by rotating the mouse scroll wheel 413, the software application for scrollable views stored in the non-volatile memory section 416 detects the scrolling event. It causes the view on display screen 410 to track the relative movement of the scrolling wheel by rendering the html data stored in cache memory 408.

When the user is deemed to have stopped moving the scroll wheel 413, the software application for scrollable views sends a request to server 403 for additional data. It requests the data to fill in the view at the point where the user had stopped scrolling. The server device 403 locates this data from client data section 421 and transmits it over the Internet 404 to client device 401. This new data is stored in cache memory 408 and rendered for display on the browser. As the user scrolls the views, the data being generated for display is retrieved from the cache memory 408. This is significant because by accessing data directly from cache memory 408, the views can be rendered quickly with the result that the displays appear smooth and responsive. Otherwise, having to request and wait for data to be sent from the server would result in slow and laggy displays.

Each time the user stops scrolling, additional data is retrieved from the server device 403 and stored in cache memory 408. Sometimes, when the user stops scrolling, a portion of that view can be found in cache memory 408. In this case, only the portion that is missing need be requested and retrieved from server device 403. Also, if the user closes the browser or switches to a different web site, the data that had been cached, remains in cache memory 408. Consequently, when the user subsequently revisits or returns, the cached data can be used to promptly render the views.

Server device 403 can simultaneously support multiple client devices. For example, server device 403 can service client device 401 and client device 402. Server device 403 is coupled to the Internet 404 through an I/O unit 417. One or more software applications 423 stored in non-volatile memory 419 are run on CPU 418. The non-volatile memory 419 also stores generic data 420 corresponding to the software applications 423. Non-volatile memory 419 is also used to store client specific data (e.g., client1 data 421 and client2 data 422). The client specific data correspond to data that was entered by a specific user or corresponds to data of a user's personal account. Thereby, when server 403 receives a request from a client device, it processes the request and transmits data packets back to the requesting client device. In one embodiment, the data packets contain image and text data that correspond to the current view of the client device where the scrolling stopped. To improve efficiency, only the image and text data that is not currently cached in the client device is transmitted by the server device 403.

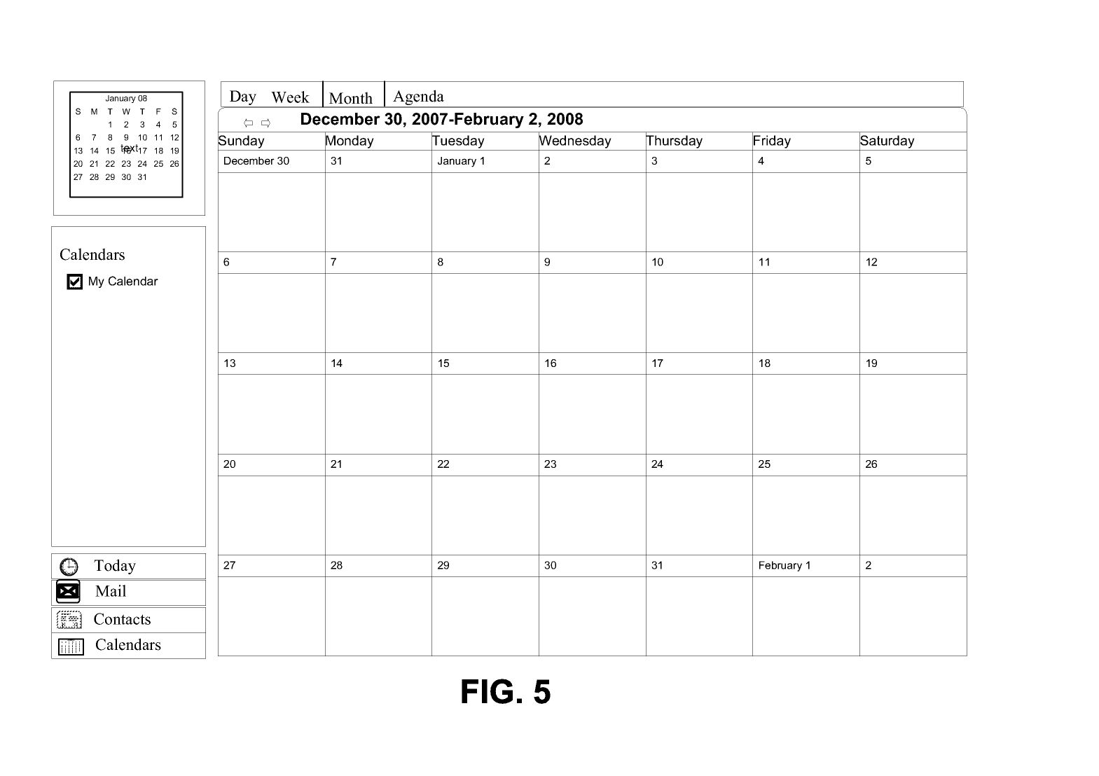

An example of a scrollable view in a client/server application is now described with reference to FIGS. 5-11. In this example, the software application is a web based calendar. The web based calendar can be set to display day, week, or month views. In this example, FIG. 5 shows a monthly view of the web based calendar. The range of Dec. 30, 2007-Feb. 2, 2008 is rendered for display on a generic web browser. This entire view being depicted currently contains no user-specific data. The background, grid, and text are all generic.

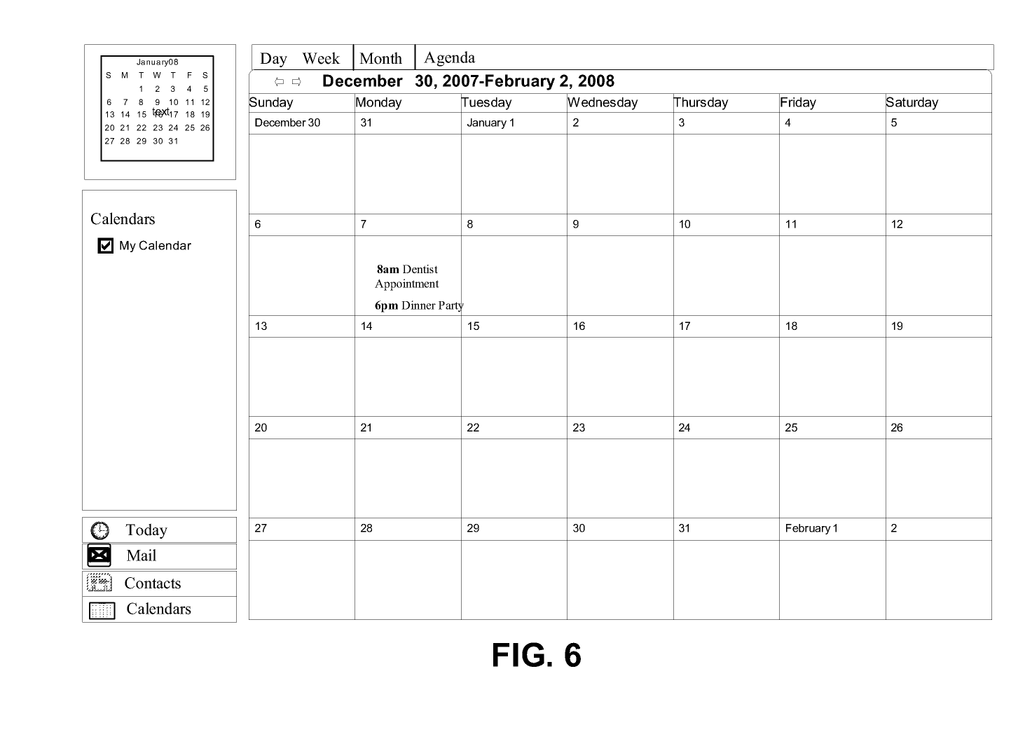

The user can use a mouse to position a cursor and click on a particular day. The user can then enter data pertaining to the selected day. For example, FIG. 6 shows the user entering two appointments for the day of Jan. 7, 2008. The user entered a “Dentist Appointment” for 8:00 am and a “Dinner Party” for 6:00 pm that day. This data is user specific and is considered to be non-generic. The user has altered the view by entering in his or her non-generic data.

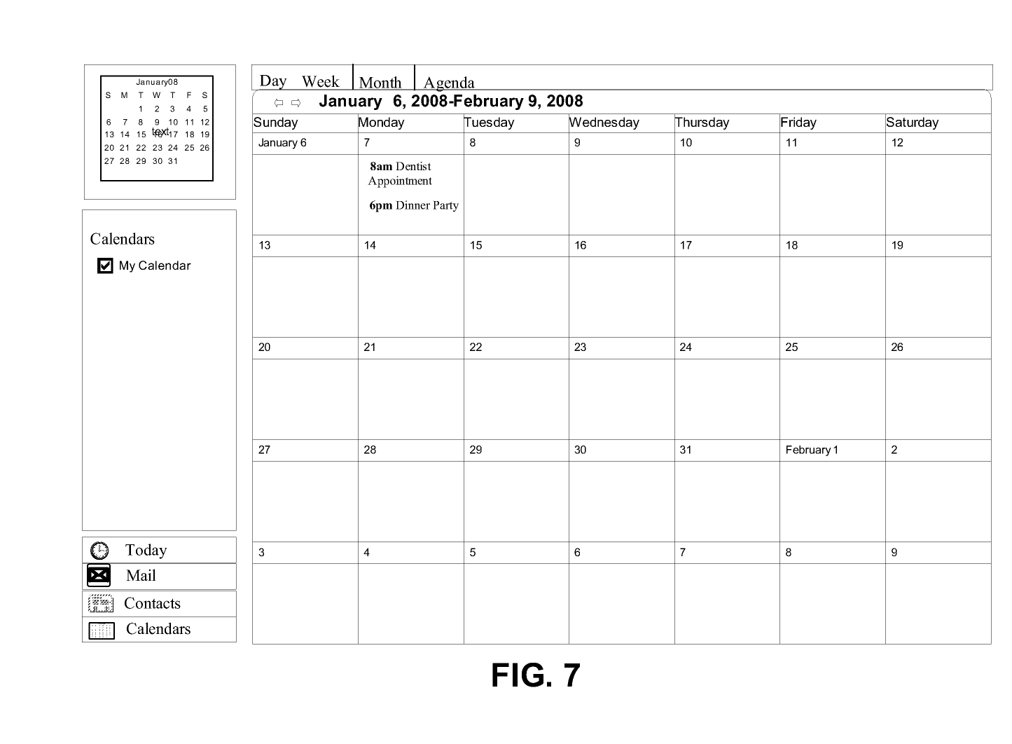

Now, suppose that the user scrolls down one week. In other words, the user rotates the scroll wheel on the mouse towards him or her to cause the calendar to shift by one week later in time. FIG. 7 shows a view whereby the user rotates the scroll wheel to display a view corresponding the range of Jan. 6, 2008-Feb. 9, 2008. Note that the non-generic entries “Dentist Appointment” and “Dinner Party” are rendered for display. The non-generic entries are rendered for display because the data was cached and was rendered for display from a previous view (the view shown in FIG. 6). This view, with the non-generic entries shown, is displayed irrespective of whether the user is temporarily scrolling through this view as he or she traverses to a different view or if the user stops at this view.

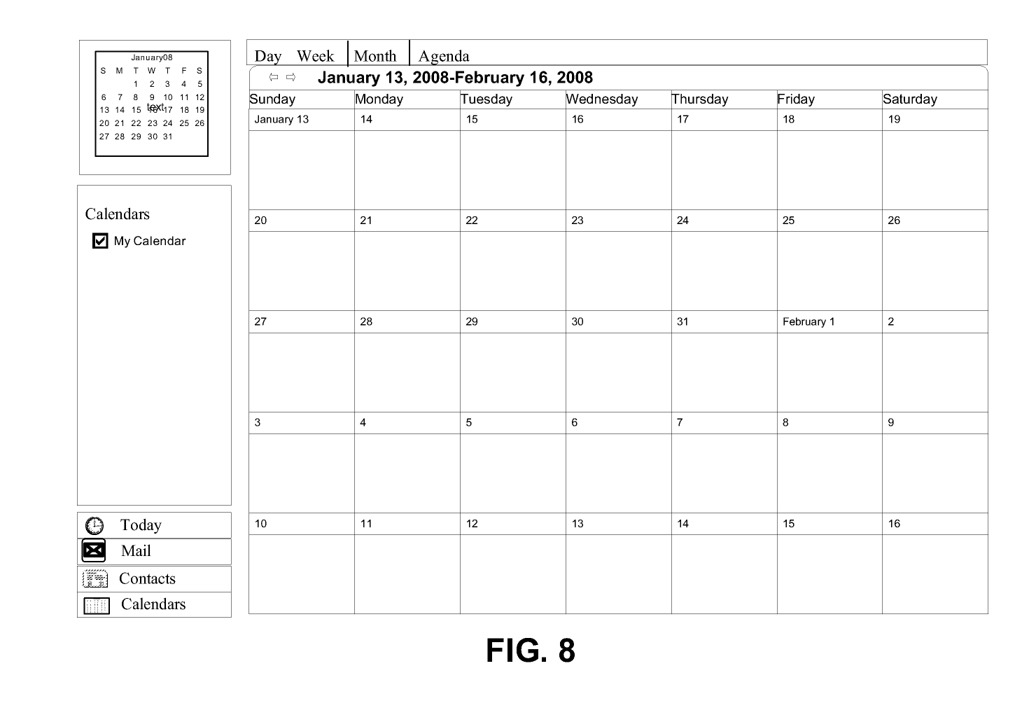

If the user does not stop, but continues scrolling by rotating the scroll wheel a bit further, the monthly view corresponding to the following week is rendered for display, as shown in FIG. 8. FIG. 8 shows the monthly view corresponding to the range of Jan. 13, 2008-Feb. 16, 2008. The non-generic entries corresponding to Jan. 7, 2008 has now been scrolled away from view.

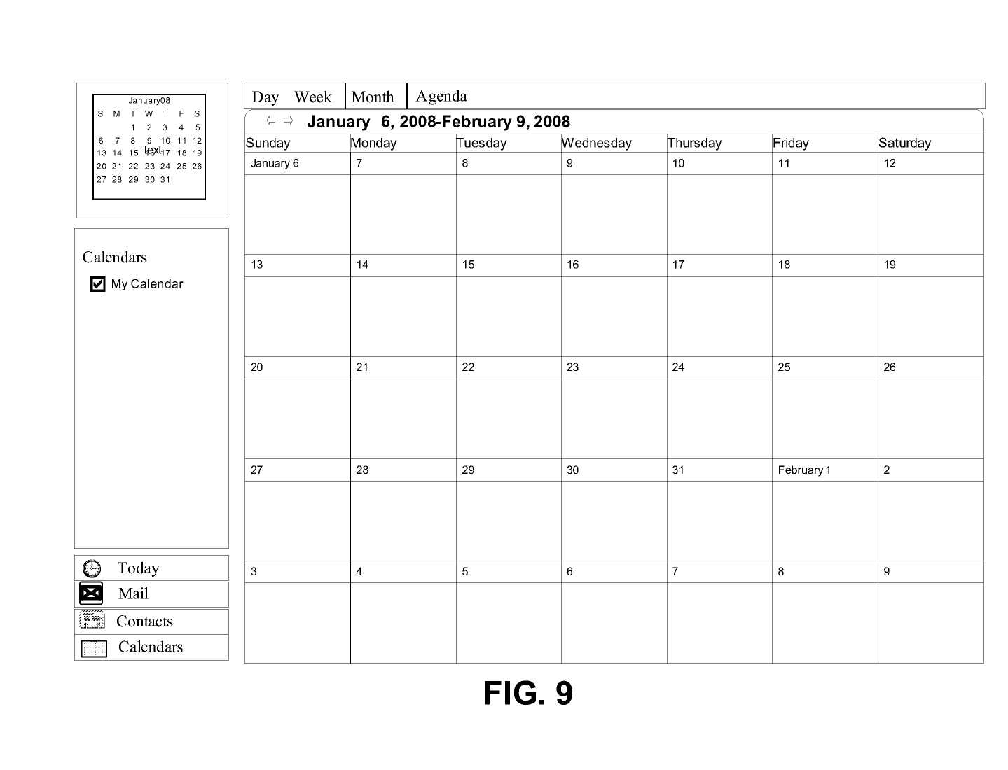

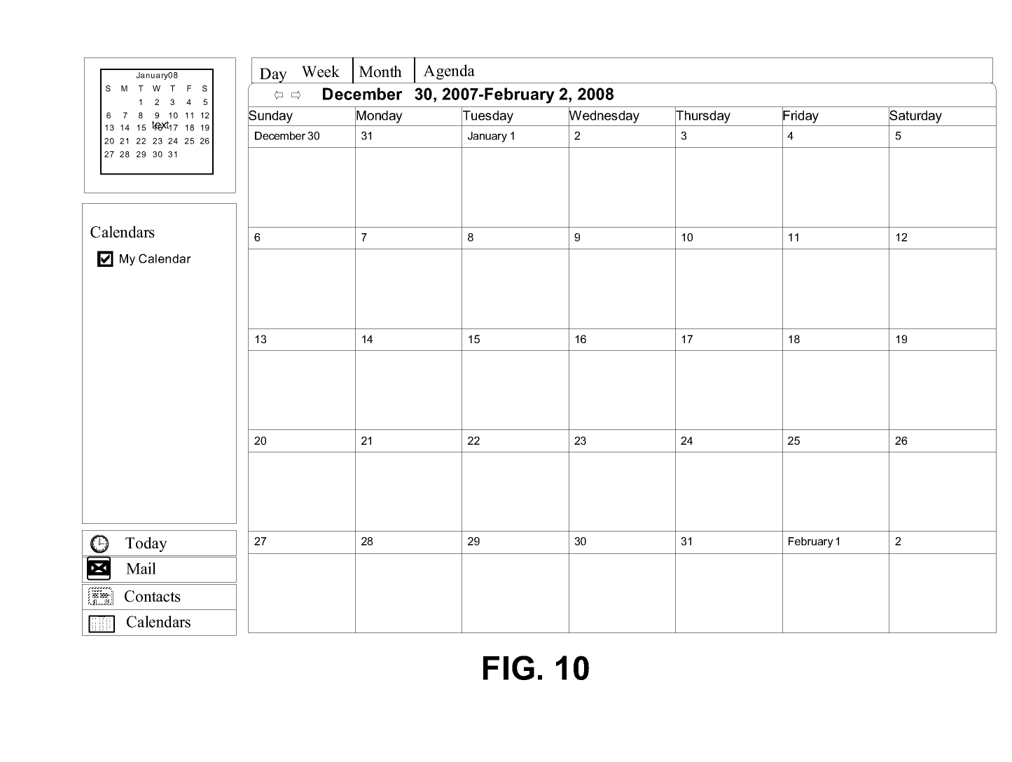

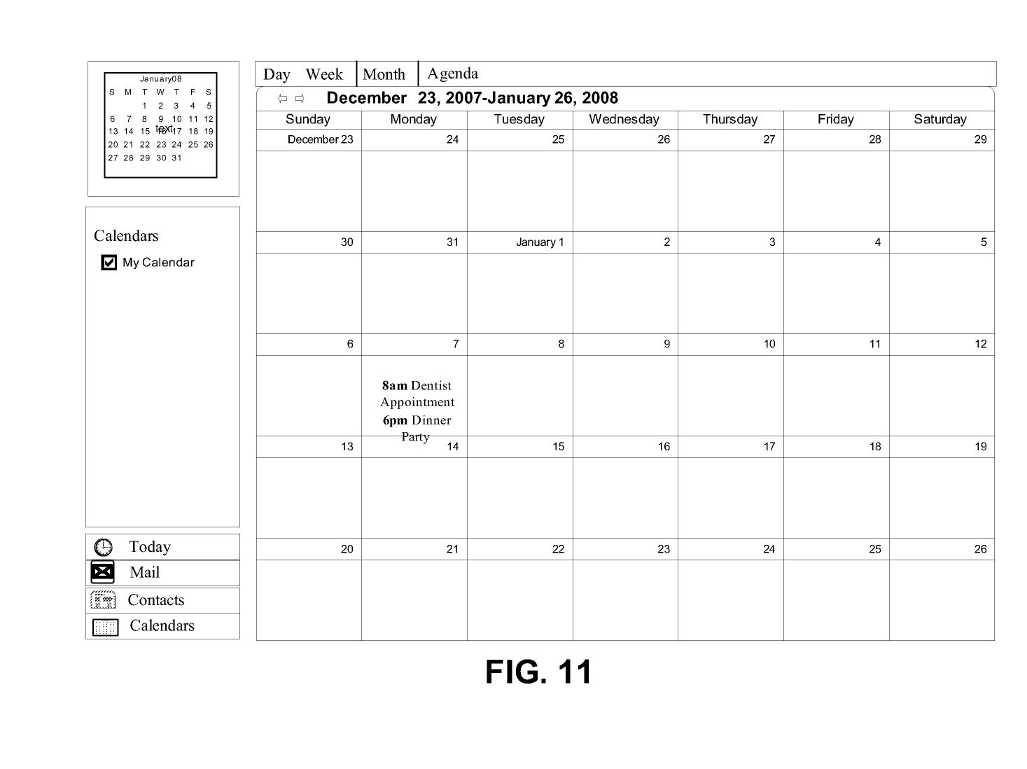

Now, suppose that the user desires to review what is or was on his or her calendar for the range of Dec. 23, 2007-Jan. 26, 2008. The user accomplishes this by rotating the scroll wheel upwards. As the scroll wheel is rotated, a series of views are temporarily rendered for display. The first view rendered for display corresponds to the monthly view with a range of Jan. 6, 2008-Feb. 9, 2008, as shown in FIG. 9. As the user continues to scroll up, the view shown in FIG. 10 is rendered for display. This monthly view corresponds to the range of Dec. 30, 2007-Feb. 2, 2008. In one embodiment, the non-generic user entries are not rendered for display as the user is still in the process of scrolling. This makes the views much faster and smoother to render during scrolling. Finally, when the user stops rotating the scroll wheel when he or she gets to the desired range of Dec. 23, 2007-Jan. 26, 2008, the monthly view shown in FIG. 11 is rendered for display. When the user stops scrolling, the software application obtains and renders the non-generic user entries. In this example, the “Dentist Appointment” and “Dinner Party” user entries are only rendered for display after the user stops scrolling.

In one embodiment, a user command (e.g., depressing and holding down the shift key or some other designated key or button) can be used in conjunction with the scroll wheel to invoke and perform a different scrolling function. For example, simultaneously holding down the shift key and rotating the scroll wheel can cause the resolution of the views to be scrollably controlled. The scrolling can increase or decrease the resolution. In the context of a calendar software application, holding down the shift key while scrolling can cause the view to zoom in from month view to multi-week view; from multi-week view to single week view; from single week view to multi-day view; and from multi-day view to day view. In similar fashion, wheeling the scroll wheel in the opposite direction while holding down the shift key can cause the view to zoom out (e.g., from day view to multi-day view; from multi-day view to single week view; from single week view to multi-week view; and from multi-week view to month view). Other scrollable functions may can be to zoom in and out of a picture, map, etc. It can be used to increase or decrease the rate of playback of video or audio files. Normal scrolling can traverse data linearly in one axis, and scrolling while holding down a key/button can traverse data linearly in a different axis.

The previous description of the disclosed embodiments is provided to enable any person skilled in the art to make or use the disclosure. Various modifications to these embodiments will be readily apparent to those skilled in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. A method of displaying a plurality of views in response to user scrolling, comprising:
requesting data from a server device;
rendering a first view for display on a client device according to the data provided by the server device;
detecting rotation of a scroll wheel;
displaying a second view while the scroll wheel is being rotated without transmitting a request for additional data from the server device;
determining when the scroll wheel has stopped rotating;
requesting additional data from the server device when the scroll wheel has stopped rotating;
rendering a third view for display on the client device according to the additional data provided by the server device.

2. The method of claim 1 further comprising:
caching the additional data in memory of the client device;
rendering the additional data for display in subsequent views when the user scrolls through those subsequent views.

3. The method of claim 1 further comprising:
setting a timer;
generating a message that the scroll wheel has stopped rotating when no movement has been detected and the timer has elapsed.

4. The method of claim 1 further comprising:
receiving HTML data from the server device and generating web page views for display on a web browser running on the client device.

5. The method of claim 4, wherein the web page views correspond to a web based calendar.

6. The method of claim 1 further comprising:
accepting user input data;
transmitting the user input data to the server device for storage;
requesting the user input data when the user stops scrolling on a fourth view that contains the user input data;
rendering the user input data as part of the fourth view for display on the client device.

7. The method of claim 1 further comprising:
accepting a user command while simultaneously detecting rotation of the scroll wheel invokes a particular scrolling function.

8. In a client/server application, a method for scrolling, comprising:
generating a first view for display, wherein the first view is comprised of generic data;
generating a plurality of views for display that track the scrolling, wherein the plurality of views only contain generic data;
generating a final view for display when the scrolling is deemed to have stopped, wherein the final view contains non-generic data that was obtained from a server device.

9. The method of claim 8 further comprising:
caching the non-generic data in a local memory.

10. The method of claim 8, wherein the first view, plurality of views, and final view are generated for display on a web browser.

11. The method of claim 8, wherein the client/server application comprises a calendar application.

12. The method of claim 11, wherein the generic data of the calendar application comprises grids and text corresponding to a calendar.

13. The method of claim 12, wherein the non-generic data of the calendar application comprises appointment information.

14. The method of claim 8, wherein the scrolling is deemed to have stopped if a pre-determined amount of time has elapsed without detecting movement of a scroll wheel.

15. The method of claim 8, wherein depressing a key or button while scrolling provides a different scrolling function.

16. The method of claim 8, wherein the client/server application comprises a first message that is generated to indicate that a user has started the scrolling, a second message that is generated to indicate the user continues the scrolling, and a third message to indicate the user stopping the scrolling.

17. A user interface device, comprising:
a memory that contains a web browser application;
a processor coupled to the memory, wherein the processor generates requests to a server to retrieve data that is common to all users of a particular software application as specified by the user and to retrieve data that is user-specific;
a rotatable scroll wheel device coupled to the processor that is used to scroll through a plurality of views;
a display that renders the plurality of views to track a user's rotation of the scroll wheel device, wherein non-cached user-specific data is only requested from the server when the user stops rotating the scroll wheel.

18. The user interface device of claim 17, wherein the user-specific data is cached and rendered for display in subsequent views.

19. The user interface device of claim 17, wherein the software application comprises a web based calendar.

20. The user interface device of claim 16 further comprising:
a timer that is used to determine whether the user has stopped rotating the scroll wheel.
